(19) United States
(12) Patent Application Publication
(10) Pub. No.: US 2016/0021834 A1
(43) Pub. Date: Jan. 28, 2016

(54) Wind Generated Ocean Water Conversion and Distribution Unit for Hurricane Risk Mitigation, Energy Creation and Data Retrieval

(71) Applicant: Diah Petros Asker, Spring Valley, CA (US)

(72) Inventor: Diah Petros Asker, Spring Valley, CA (US)

(21) Appl. No.: 14/338,118

(22) Filed: Jul. 22, 2014

(51) Int. Cl. A01G 15/00; B05B 12/08; F28F 9/00; F03D 9/00

(52) U.S. Cl. CPC A01G 15/00; F03D 9/001; B05B 12/08; F28F 9/00

(57) ABSTRACT

Wind generated ocean water conversion and distribution unit integrated into the existing patented Windfloat technology to better mitigate hurricane risk, while creating energy and retrieve future weather condition data. The newly added technology employs a sensor activated cooling unit which propels cold moisture into the ocean atmosphere in order to help prevent warm air conditions which create potential hurricane conditions. The cooling unit is integrated into the existing Principle Power's Windfloat (patented) offshore technology. Non-hurricane season generated energy is created via the traditional technology found in the Windfloat unit(s). A data retrieval device may transmit weather and ocean condition information to an onshore collection center and monitored via current weather collection methods and computer programs.

### CROSS-REFERENCE TO RELATED APPLICATIONS

This invention utilizes benefits derived from a prior filed provisional patent application with listing of application number and/or international application number, filing date and relationship of the application (if any) as follows:
WindFloat Patent: U.S. Pat. No. 8,471,396 B2
Date of Patent: Jun. 25, 2013

This relationship of the above related application to this current application is one of utilizing the WindFloat patent and technology as an integral base to which further technological components are integrated into the core structure in order to complete the proposed invention for the purpose of hurricane risk mitigation as further described in section III, (Brief Summary of the Invention).

### BACKGROUND OF THE INVENTION

The convergence of minimum warm ocean water temperatures of 80° Fahrenheit and moist ocean air set ideal conditions for the creation of potentially devastating hurricanes. When moist warm air rapidly rises and encounters cooler air it causes warm water vapor to condense, which in turn creates storm clouds, potential rain, and the release of heat, warming the above cooler air which rises and creates warm humid air from the below ocean water. The cycle is repeated as more warm moist air absorbs into the developing storm and more humid air is transferred from the ocean surface into the atmosphere. A swirling pattern is thus created around a center (eye).

As winds converge, water vapor is pushed upwards and warm air is circulated and wind speed is accelerated. Additionally strong winds at higher altitudes assist in divergence of warm water away from the storm center and into a classic cyclone pattern. High air pressure above altitudes of 9,000 meters may also contribute to the retraction of heat from the storm center and the cooling of rising air. Wind speeds increase as high-pressure air joins the low-pressure center of the storm.

As development of the hurricane occurs, it sets the stage for potential long-term damage and devastation not only to urban infrastructure and land, but to the displacement and loss of human life affected by direct and indirect geographic proximity.

### BRIEF SUMMARY OF THE INVENTION

The invention serves a tri-fold purpose (benefit). First and foremost, the invention employs a cooling unit which draws electrical energy from existent wind turbines. The unit, distribution apparatus and related components are integrated into Principle Power's WindFloat offshore technology within the wind turbine tower and tower support apparatus. Sensor activation chills newly acquired warm tank water (upon the increase of water temperature and gauging of warm water conditions that may indicate hurricane potential), then forces a constant upward ejection of newly generated cold moisture which is sent through the attached propulsion distribution pipe and finally released into the atmosphere via industrial ejectors. The cool moisture ejected into the atmosphere at the tower's lower level is evenly redistributed into the atmosphere, creating a cooling effect in order to neutralize warm air in order to decrease potential hurricane level activity.

Secondly, in addition to the wind turbines creating the energy required to operate the cooling unit and subsequent distribution apparatus, additional or non-hurricane season generated energy would be transferred into electrical energy for usage on land as intended by the original Windfloat application (U.S. Pat. No. 8,471,396 B2).

Thirdly, at various time intervals, the unit can be equipped with a data retrieval device (concept), which would transmit weather and ocean condition data to a collection center located onshore. The transmission of data will allow for scientists to better understand and monitor the complexity of storms, hurricanes, tsunamis and other potentially devastating conditions which generate in ocean waters.

### BRIEF DESCRIPTION OF THE SEVERAL VIEWS OF THE DRAWINGS

The invention is illustrated in the accompanying drawings in which:

FIG. 1 is a perspective view of the entire Windfloat unit (from the water mooring system and anchors to the highest point of rotor (blade) rotation with view of the water conversion and distribution unit and related components.

FIG. 2 is an elevation of the cooling tank unit, suction and distribution pipes, generator, motor pump, sensors and propulsion distribution apparatus.

FIG. 3 is a section of the generator and motor driven pump used to transport newly cooled moisture to the propulsion distribution apparatus via electric energy generated by the wind turbine blades.

FIG. 4 is a top view of the propulsion distribution apparatus and schematic view of cold moisture discharged back into the atmosphere.

FIG. 5 is a schematic indicating the power generator control system, motor pump and sensor units for the conversion and distribution apparatus.

### DETAILED DESCRIPTION OF THE INVENTION

FIG. 1 shows a frontal isometric view of the patented deep water Windfloat system with the cold moisture distribution apparatus (1) built into the base of the central tower (2). There are circular openings for high pressure moisture ejection (3). A power generator, from which energy is acquired when the wind turbine is operational, is permanently mounted to the actual tower support column (4) which in turn supplies turbine generated energy to an electric motor operated water pump also mounted on the tower column (5). The pump moves sensor indicated (9), warm surface ocean water via an integrated suction pipe (6), into the cooling tank built within the below tower column (7). Upon a second sensor (10), determination that water temperatures have reached a minimum 32° F./0° C., a second propulsion distribution pipe (8), transports the cold water to the distributors (3), creating jets of cold water for outward propulsion into the atmosphere.

This process is constantly repeated as newly acquired warm ocean water is cooled to above referenced temperatures and transferred for redistribution into the atmosphere until weather conditions are stabilized.

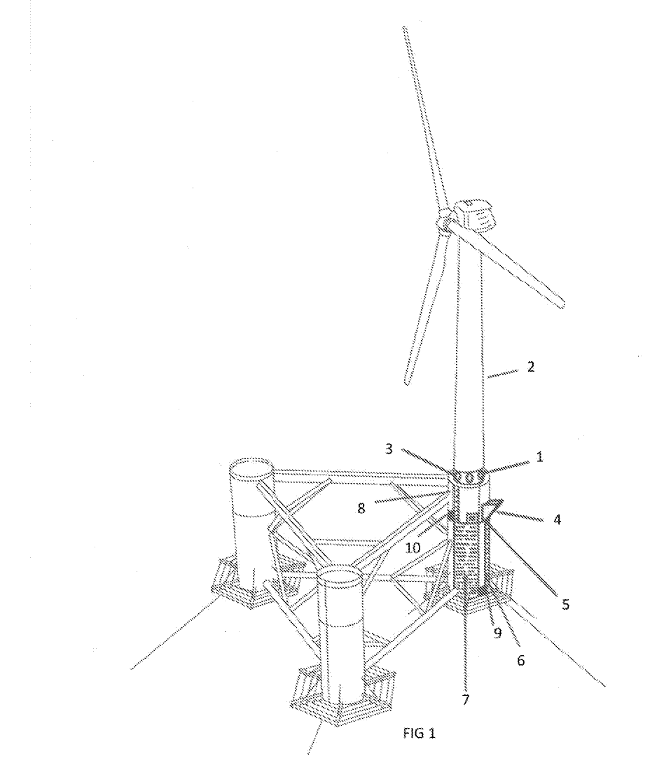

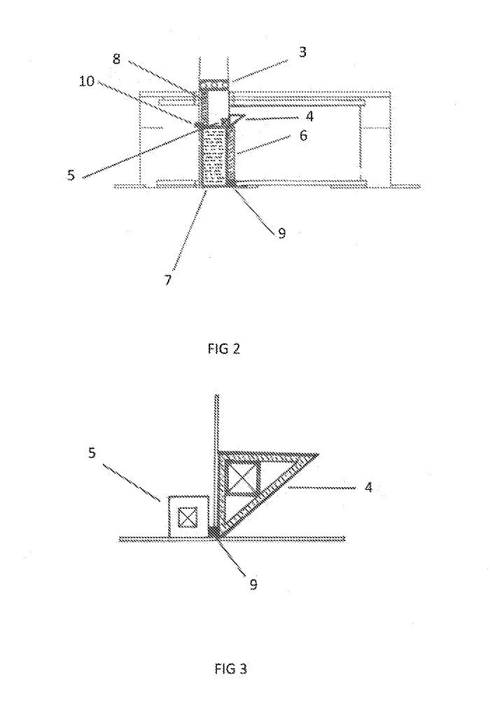

Referring to FIG. 2, an elevation shows a schematic diagram of the cooling tank, suction and distribution pipe, generator, motor pump, sensors and propulsion distribution apparatus.

FIG. 3 is a schematic section of the generator and motor driven pump which is used to transport newly cooled moisture to the propulsion distribution apparatus using electric energy generated by the wind turbine.

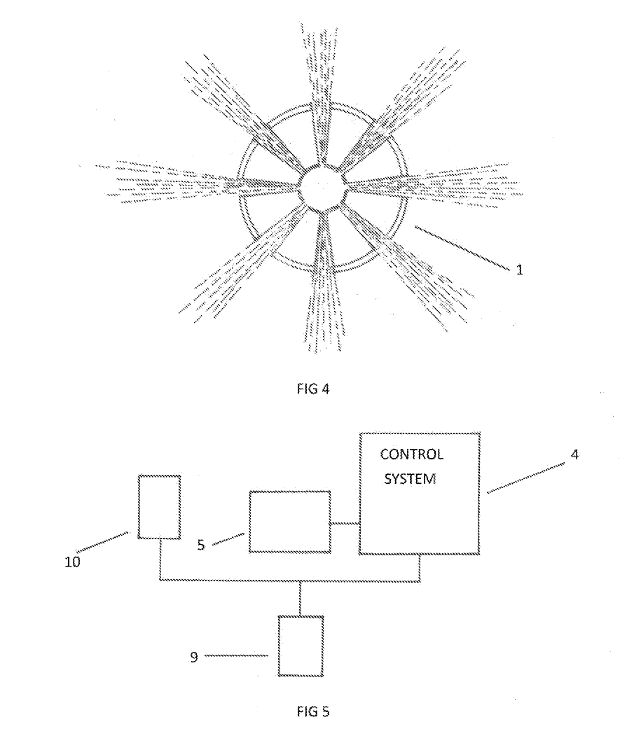

FIG. 4 is a top view of the propulsion distribution apparatus and schematic diagram of the cold moisture discharge back into the atmosphere.

Referring to FIG. 5, a schematic diagram is presented indicating the control system and sensor units used to operate the conversion and distribution apparatus.

The ocean water and distribution unit described herein operates within the larger framework of the patented Windfloat system created by Principle Power and is integrally fabricated on shore. The herein described concept ideally benefits from the existing advantages of innovative offshore energy generation found in the Windfloat system including but not limited to: dynamic stability; onshore fabrication and assembly; distant off shore placement allowing for placement in previously inaccessible deep water locations and mostly out of visual site from land; a mooring and anchor system which allows for portability and cost-effectiveness; custom design integration based on site statistics and intended usage.

The unit can also be equipped with a data retrieval device, which would transmit weather and ocean condition data to a collection center located on land. The transmission of data will allow for scientists to better understand and monitor the complexity of storms, hurricanes, tsunamis and other potentially devastating conditions which generate in ocean waters.

1. An ocean water conversion and distribution unit, comprising:
a generator attached to the tower support column which provides energy from the wind turbine for operation,
a motor operated water pump mounted on the tower column to move warm surface ocean water,
an ocean water suction pipe fabricated onto the tower column which draws warm ocean water,
an exterior sensor fabricated onto the side of the suction pipe to determine the warmth of the ocean water temperature,
an interior sensor fabricated within a cooling tank to determine when water temperatures have reached a minimum 32° F./0° C. for distribution,
an ocean water cooling tank unit built within a the pre-existent Windfloat system tower support column,
a distribution pipe with propulsion device extending from the tower column at the top point of the cooling tank to the base of the central column for cold water transport,
a 360° cold moisture distribution apparatus built into the base of the central tower with circular openings for high pressure cold moisture propulsion into the atmosphere.
